(19) United States
(12) Patent Application Publication
(10) Pub. No.: US 2005/0095003 A1
(43) Pub. Date: May 5, 2005

(54) Quantum approach for coordinating activities

(76) Inventors: Bernardo A. Huberman, Palo Alto, CA (US); Tad Hogg, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,544

(22) Filed: Oct. 30, 2003

(51) Int. Cl. H04B 10/00

(52) U.S. Cl. 398/140; 398/106

(57) ABSTRACT

Coordination of actions at two or more nodes is achieved. In one example embodiment, quantum-entangled particles are generated and sent to at least two nodes. The quantum state of an observed one of the particles is detected, thereby fixing the quantum state of the observed particle as well as the other ones of the entangled particles. At two or more of the nodes, an action or process is carried out as a function of the fixed quantum state. With this approach, separate nodes can coordinate decisions, timing and other functions without necessarily communicating with one another and while maintaining a random characteristic of the coordination.

### FIELD OF THE INVENTION

The present disclosure generally relates to coordinating activities at nodes using quantum methods.

### BACKGROUND

Prior approaches to coordination, decision making and problem solving have typically required explicit communication, prior commitment or trusted third parties. When such modes of coordination are not desirable for certain applications, for example when communication is impossible or when a trusted third party does not exist, decision making and problem solving become more challenging. For instance, the existence of multiple equilibria in economic systems can lead to coordination failures and consequently to inefficient outcomes. Examples of such applications include business entities having to decide whether or not to enter a competitive market and how to position their offerings and social entities having to coordinate the resolution of social dilemmas.

Coordination problems have long been studied in the context of game theory, where the coordination game is specified by a payoff matrix that yields several Nash equilibria (see, e.g., T. C. Schelling, The Strategy of Conflict, Oxford University Press, Oxford, 1960; Drew Fudenberg et al., Game Theory, MIT Press, Cambridge, Mass., 2000; and Colin Camerer, Behavioral game Theory: Experiments on Strategic Interaction, Princeton University Press, Princeton, N.J., 2003).

One type of coordination problem arises in the context of private communications. In some applications, such as military or business applications, two entities may wish to communicate privately or to otherwise secretly coordinate actions. Previous approaches to the coordination of military strategy have involved the use of encryption or predefined courses of action for two separate units. For business entities, encryption is often used to protect data communicated between individual nodes. In each of these instances, however, encrypted data is susceptible to interception and discovery. In addition, predefined courses of action can often be anticipated, relative to random plans, and are also susceptible to discovery.

The execution of actions or decisions that involve a random element and are also coordinated at different locations has not been readily ascertained due to these and other challenges.

### SUMMARY

According to an example embodiment of the present invention, actions may be coordinated at two or more nodes using quantum-entangled particles. At least two quantum-entangled particles are generated and sent to two or more different nodes. The state of one of the quantum-entangled particles is detected, thereby fixing the state of the other ones of the quantum-entangled particles. At two of the nodes, the state of the quantum-entangled particle at the respective nodes may be observed and used to generate a response. Due to the nature of quantum-entangled particles, the observed state is the same for each node. In this regard, actions, decisions and other events may be coordinated, relative to the state of the quantum-entangled particles, for each of the two or more different nodes. In addition, this coordination can be effected without necessarily communicating between the two or more nodes.

In another example embodiment of the present invention, two or more actions may be predefined at each node, each action being correlated to a particular state of the quantum-entangled particles. When the state of the quantum-entangled particles is fixed and subsequently observed, the predefined action that is correlated to the observed state may be selected for performance. In one implementation, each node has the same predefined action, such that identical actions are performed at each node, without communication therebetween and with a random characteristic as established by the nature of the quantum-entangled particles.

In another example embodiment of the present invention, two or more sets of quantum-entangled particles are generated, with a representative one of each set being sent to two different nodes. The state of one of the particles from each set is observed, thereby respectively fixing the state of the other ones of the particles in each set. At each of the two different nodes, the fixed state of the representative ones of each set of quantum-entangled particles may be observed. These two or more observed states may be used in combination to produce a consistent output at each of the two different nodes.

It will be appreciated that various other embodiments are set forth in the Detailed Description and Claims that follow.

### BRIEF DESCRIPTION OF THE DRAWINGS

FIG. 1 is a flow diagram showing the use of quantum entangled photon pairs, according to various embodiments of the present invention;

FIG. 2 is a flow diagram showing an encoding approach involving quantum entangled particles, according to other embodiments of the present invention;

FIG. 3 is a flow diagram showing a coordination approach involving quantum-entangled particles, according to yet other embodiments of the present invention;

FIG. 4 is a system for selecting and performing an action as a function of the state of quantum-entangled particles, according to various embodiments of the present invention; and

FIG. 5 is a flow diagram showing an approach for selecting an action from a set of predefined actions as a function of the state of quantum-entangled particles, according to other embodiments of the present invention.

### DETAILED DESCRIPTION

The present invention is believed to be applicable to a variety of approaches involving quantum entanglement and has been found to be particularly applicable and beneficial in applying quantum-entangled particles in the coordination, application and timing of actions and/or functions at different nodes.

According to an example embodiment of the present invention, quantum-entangled particles are used in performing an action or function at two separate nodes, with the state of one of the particles being detected at one of the nodes, fixing the state of the remaining particles as a result thereof. This fixed state of the quantum-entangled particles is processed at two separate nodes and used for one or more of a variety of applications, such as selecting a predefined action identified as a function of the fixed state. With this approach, two separate nodes are provided with a particle exhibiting a random state that is simultaneously fixed at both nodes without necessary communication therebetween and, in some instances, with anonymity between the nodes. The fixed state can then be used in decision-making, coordination, timing, encoding and other applications, certain examples of which are discussed further below.

A variety of types of quantum-entangled particles can be used in connection with the various example embodiments discussed herein, and various characteristics of entangled particles can be detected and used to identify a quantum-entangled state thereof. The term “particles” as used here may be implemented with any entity that can be quantum entangled, with “entanglement” generally referring to the condition of individual ones of entangled particles having generally the same quantum state. When the quantum state of one of these entangled particles is fixed, the other entangled particles are also fixed in the same state. Quantum-entangled particles such as photons, ions, waveform-type particles and others are used to establish a consistent state that is detectable at two distinct nodes. Characteristics used to identify such a consistent state are selected to suit the particular type of particle and entangled state.

In one instance quantum-entangled photons are created using a parametric down conversion approach in which a laser produces a pump photon that splits to form a pair of entangled daughter photons. For example, an argon laser can be used to direct laser light to adjacent, nonlinear optical crystals to generate the pump photon, which spontaneously splits into the daughter photons. The daughter photons are entangled in state, thus quantum-correlated in time, space and often in polarization. A beam splitter or other arrangement separates and directs the daughter photons along separate paths that lead to separate detectors (e.g., a silicon avalanche photodiode operated in the geiger mode).

A characteristic of the quantum state of one of the photons (e.g., polarization or frequency) is detected at one of the separate detectors, thereby fixing the state of the photon as well as other photons entangled therewith. For instance, when using a silicon avalanche photodiode as discussed above, an output (e.g., voltage) of the photodiode can be used to identify a characteristic such as intensity of the detected photon(s) that can be related to the quantum state thereof. The output is optionally automatically processed, for example using a computer and voltage-responsive circuit to correlate an output from the avalanche photodiode to a particular intensity and corresponding state. For general information regarding entangled particles and for specific information regarding approaches to the creation of entangled particles that can be used in connection with one or more example embodiments discussed herein, reference may be made to the following documents: Paul G. Kwait et al., Experimental Verification of Decoherence-Free Subspaces, Science, Vol. 290, Oct. 20, 2000 at 498; C. A. Sackett, et al., Experimental Entanglement of Four Particles, Nature 404, 256-259 (2000). These documents are fully incorporated herein by reference.

According to another example embodiment of the present invention, entangled photons are generated and sent to first and second nodes where the entangled photons are used to execute predefined actions. An entanglement approach such as the parametric down conversion approach discussed above is used to generate entangled photon pairs, which are split and sent to the nodes. At one of the nodes, the state of one of the entangled photons is observed. This observation fixes the state of the observed photon as well as other photons entangled with it. Such fixation is in accordance with the principles behind quantum entanglement, for example as discussed above. Once the state is fixed it provides a random variable, i.e., with the state of the photon randomly changing until fixed, that can be used at two separate locations to execute predefined actions without communication between the two nodes.

Depending upon the nature of the photons and the characteristics of the entanglement, the state of the photons is detected using one or more of a variety of approaches. For instance, the spin of one of the entangled photons can be optically detected by observing a response of the entangled photon to light (e.g., the brightness of a response to laser illumination). This observation fixes the state of other photons entangled with the observed photon. The response is compared to a known response for a particular state and, therefrom, the state of the photon is detected. The same response is then observed from other photons entangled with the observed photon, now fixed in state, with the response being used to facilitate coordinated and/or predefined actions at independent nodes.

The detected state of the entangled particles is used to generate a variety of actions, depending upon the implementation. In one implementation, two independent nodes use the state of entangled particles to implement a particular action that has been predefined as a function of an entangled state. For instance, two or more actions can be defined by different states of an entangled particle or, in the event where different particles having different entanglement are used, the actions can be defined by a combination of states of the different particles. These predefined actions are stored at the two independent nodes and, upon detection of the state(s) of the entangled particles, the one of the stored actions that is defined by the detected state(s) is executed. These stored actions may, for instance, involve timing coordination, the selection of alternative actions, the insertion of a random variable defined by the state(s) into a function such as a decryption algorithm, or others. Using a simple example, when first and second actions are respectively defined by first and second quantum states, the detection of the first quantum state results in the first action being performed and the detection of the second quantum state results in the second action being performed.

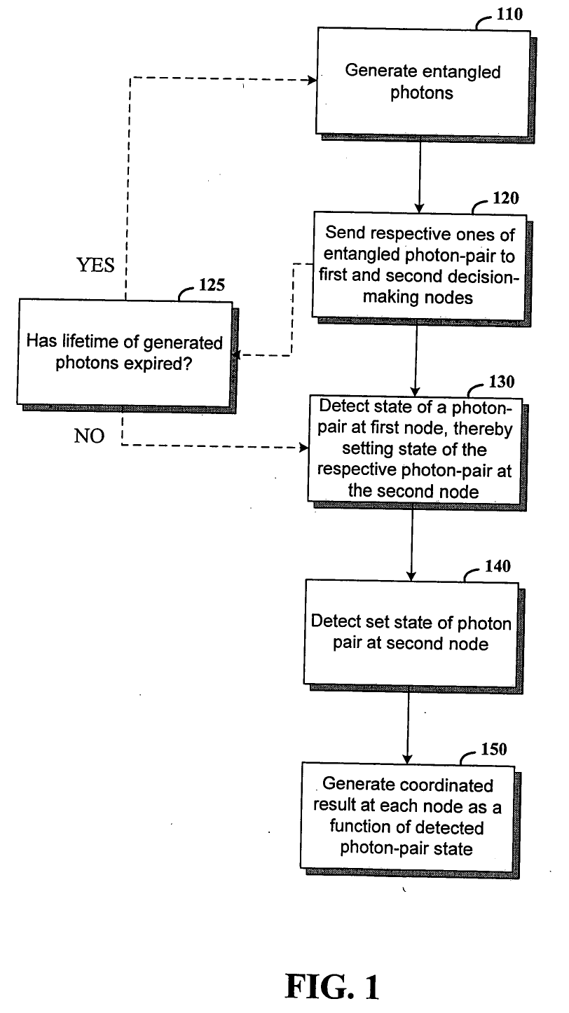

Turning now to the figures, FIG. 1 is a flow diagram showing an approach to coordination involving quantum entanglement, according to another example embodiment of the present invention. At block 110, entangled photon pairs are generated using parametric down conversion wherein a pair of entangled photons are created, for example, using a pump generation approach with a laser as discussed above. At block 120, respective ones of an entangled photon pair are sent to first and second decision-making nodes. The state of one of the photons is detected at block 130, whereby the state of the other one of the pair of photons is set, with the set state being detected at block 140. At block 150, a coordinated result is generated at each node as a function of the detected state of the photon-pair.

In a more particular implementation, again referring to FIG. 1, the expected length of entanglement is identified and used to ensure that the same state can be detected at two different nodes over a particular time period. For example, when photons are entangled for a relatively long period of time, their entangled characteristics can deteriorate. This deterioration can occur, for example, as a function of environmental conditions surrounding and affecting the entangled photons and/or the distance that separates the entangled photons.

Using an expected lifetime of entanglement, and depending upon the application and environment, a check for the expiration of the expected lifetime of entanglement is performed at block 125, after the respective ones of entangled photon-pairs are sent to first and second decision-making nodes. If the lifetime of the generated photons has expired at block 125, the process continues at block 110 with the generation of new entangled photons. If the lifetime of the generated photons has not expired at block 125, the process continues at block 130 where the state of a photon-pair is detected at the first node. The solid-lined connector between blocks 120 and 130 is thus not used in this instance, and the dashed-lined connectors to block 125 are followed. Using this approach, the correlation of the states of the entangled photons is ensured, enhancing the ability to account for conditions (environmental and others) that can be detrimental to the maintenance of entangled states.

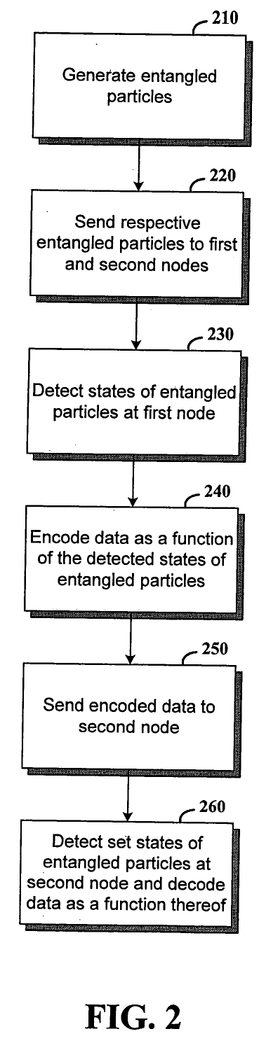

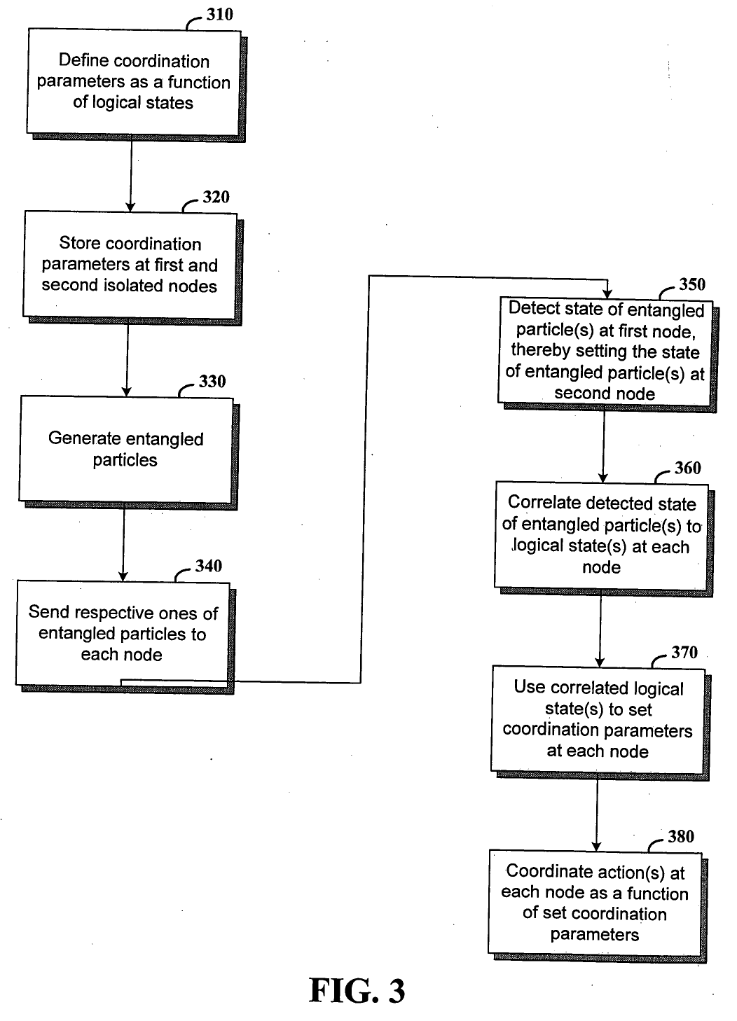

A variety of coordinated results can be achieved in the manner shown in FIG. 1. For example, an output that relies upon encoded data can be identified at two decision-making nodes using the state of the photon-pair as part of an encoding key. FIG. 2 below shows a more specific encoding-type application. Another type of coordinated result that can be implemented in connection with the approach shown in FIG. 1 involves the coordination of actions. For instance, when two military commanders need to coordinate the timing of an attack, entangled pairs can be used to coordinate results involving a timing function for each commander and without necessarily communicating between the two commanders. FIG. 3 below discusses a more specific approach to the coordination of actions involving entangled particles such as photons. In other implementations, economic results can be coordinated at each node as discussed in connection with block 150 of FIG. 1. For instance, when two economic entities agree to coordinate results by selecting one of two generally equivalent courses of action, the entangled state of the photons can be used to separately identify a coordinated random course of action at two nodes.

Referring now to FIG. 2, a flow diagram shows an encoding approach involving quantum-entangled particles in accordance with another example embodiment of the present invention. At block 210, a plurality of entangled particles is generated with different sets of the particles having different entanglement. Respective ones of the sets of entangled particles are sent to first and second nodes at block 220. The respective states of the entangled particles are detected at the first node at block 230, whereby the state of other entangled particles is fixed. For instance, if first and second sets of entangled particles are generated, detecting the state of a representative one of the entangled particles from each set fixes the state of all of the other particles in each respective set of entangled particles. Each set of entangled particles thus has an independently fixed quantum state, relative to other sets.

After the state of the entangled particles is fixed, data is encoded at block 240 using the fixed states. The encoding is carried out using one or more of a variety of approaches such as those typically implemented for encryption, CDMA (code division multi-access) coding and wireless applications. For instance, random bits can be assigned a value that is a function of the state of selected entangled particles. These random bits can then be used in the establishment an encryption key or similar function to encode data, either directly or indirectly. The encoding can be implemented using commonly available technology, with random inputs (e.g., bits) being set or selected by the quantum-entangled state of the particles, for example, with the state being used to select from two or more encryption functions.

The number of sets of entangled particles used for the encoding is selected to achieve a sufficient number of different random inputs for the encoding approach being implemented. For instance, if 128-bit encryption is used, 128 differently-entangled particle sets can be generated and used at two or more nodes to form a 128-bit key that is identical at each node. Other approaches involving the indirect use of the entangled particle sets to generate an encryption (or encoding) key, for example by using the states of the entangled particles to select a random number generator function, can also be used to generate consistent encryption data. For instance, with two locations using a similar cryptographic device, the random bits can be used as a random seed for indirectly generating encryption code that will be consistent at both locations.

After the data has been encoded at block 240, the encoded data is sent to the second node at block 250. If the encoded data happens to be intercepted by an adverse party, the data is protected by the random nature of the encoding as facilitated by the use of the entangled particles. Without knowledge of the entangled states of the particles, the adverse party is generally prevented from decoding and otherwise ascertaining the information included with the encoded data. At the second node, the set (fixed) states of the entangled particles are detected as shown in block 260. These fixed states of the entangled particles are used to decode the data, for example by using the fixed states to generate a key as discussed above.

FIG. 3 is a flow diagram showing a coordination approach involving quantum-entangled particles, according to another example embodiment of the present invention. At block 310, coordination parameters are defined as a function of logical states. These predefined coordination parameters are stored at first and second nodes as shown at block 320, with the first and second nodes being communicatively isolated from one. Entangled particles are generated at block 330, for example, at a third node with respective ones of the entangled particles being sent to each of the first and second nodes at block 340. Alternatively, the entangled particles are generated at one of the first and second nodes and sent to the other one of the first and second nodes, again resulting in respective ones of the entangled particles at each node. In this regard, each node has at least one particle that is entangled with a particle at the other node, the particles at each node having a consistent state due to the entangled nature of the particles.

Once the entangled particles are sent to each node, the state of at least one of the entangled particles is detected at the first node as shown at block 350 and thus fixes the state of the other entangled particles. In some implementations, the state of only one entangled particle is detected and fixed. In other implementations involving two or more sets of differently entangled particles, the states of representative ones of the sets of differently entangled particles are detected and accordingly fixed. At block 360, the detected state of entangled particle(s) is correlated to one or more logical states at each node. These correlated logical states are used at block 370 to set coordination parameters at each node, with actions being coordinated as a function of the coordination parameters at block 380. For instance, coordination parameters including a pseudorandom code can be constructed using the logical states, either directly from the logical states or as a function of the logical states and other stored information.

Many types of actions can be coordinated using the approach shown in and discussed in connection with FIG. 3. For example, as discussed above and in one implementation, military commanders can use the correlated logical states at block 370 to set coordination parameters such as time and place of attack. At block 380, the attack is carried out at the time and place specified by the coordination parameters. A processor or other device at each node can be implemented to communicate a time to a user at each node, for example by displaying a time on a computer screen. With this approach, military commanders can execute operations that are random, but coordinated, without directly communicating information that is necessary for defining and executing the random, coordinated action.

In another example, two nodes at different locations in an experimental setting use the correlated logical states at block 370 to coordinate experimental procedures without necessarily directly communicating with one another. This approach is useful, for instance, in experimental applications wherein the carrying out of functions that exhibit a random nature is desirable. When different experimental applications are isolated, this approach can also be used to coordinate random functions without necessarily communicating between the nodes to establish the coordination.

The coordination parameters set at block 370 are selected and implemented using one or more of a variety of approaches, depending upon the application, available equipment and desired coordination characteristics. In one such instance, computer-type arrangements at the first and second nodes are similarly programmed to generate a result as a function of coordination parameters. When similar inputs are provided to the computers at each node, they generate a coordinated output that is similar for both computers. After the initial programming of the computer-type arrangements and the delivery of the entangled particles, this coordinated output is generated without necessarily involving any further communication between the two nodes.

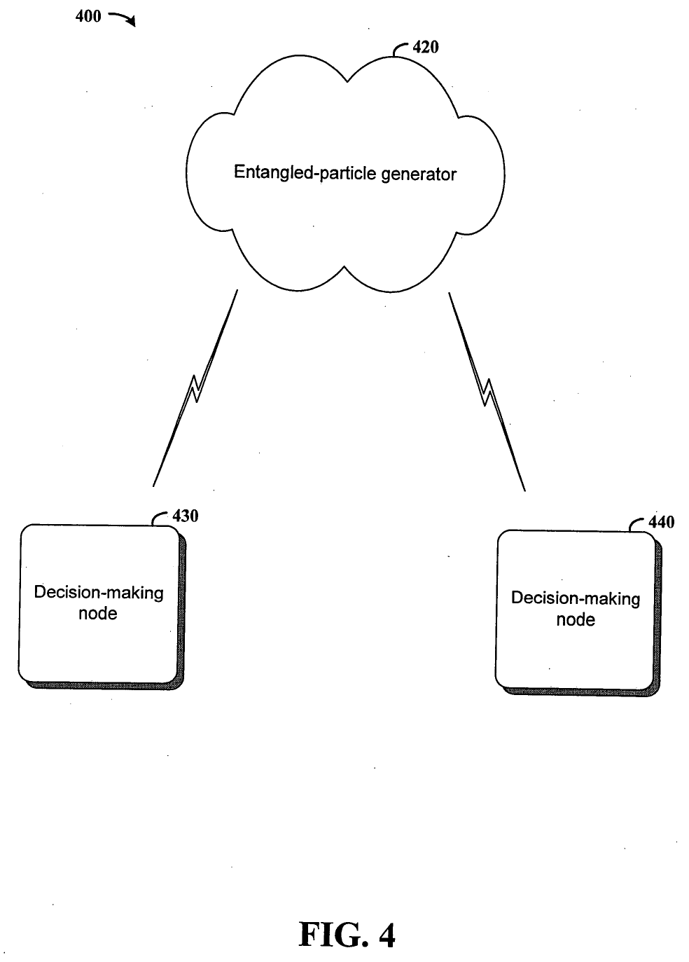

FIG. 4 is a system 400 for selecting and performing an action as a function of the state of quantum-entangled particles, according to another example embodiment of the present invention. An entangled-particle generator 420 is used to generate entangled particles. The type of entangled-particle generator 420 is selected to suit the particular implementation to which the system 400 is to be applied. For example, where entangled photon-pairs are to be generated, the entangled-particle generator 420 may be implemented with an apparatus designed for parametric down-conversion as discussed above.

Respective ones of similarly-entangled particles are sent to decision-making nodes 430 and 440 over a communications medium that is, like the entangled-particle generator, selected to suit the particular implementation to which the system 400 is to be applied. For instance, when entangled photons are generated, a communications medium that is capable of delivering the photons is used, such as a fiber optic cable or a gaseous medium (e.g., air). When other types of entangled particles are generated, the communications medium is similarly selected to facilitate the delivery of the particular type of particle. For instance, when radio frequency (RF) wave-type particles are entangled, a medium that conducts RF signals is used. When electrons are entangled, a medium that conducts electrons is used.

The decision-making nodes 430 and 440 include equipment that is configured to receive the entangled particles and detect the state thereof. For instance where entangled photon-pairs are used, the decision-making nodes 430 and 440 each include an arrangement for observing the photons. This observation is used, for example, to determine the spin of the photons and relate characteristics of the spin to users at the respective decision-making nodes.

In one instance the respective decision-making nodes 430 and 440 include processing equipment such as computers programmed to process detected characteristics of the entangled particles, with the processed characteristics being used to facilitate a decision. For example, the state of detected entangled particles can be used to identify a random bit that in turn is used by the computer to generate an output. Such an output can be tailored for selecting and performing a particular action, predefined or otherwise.

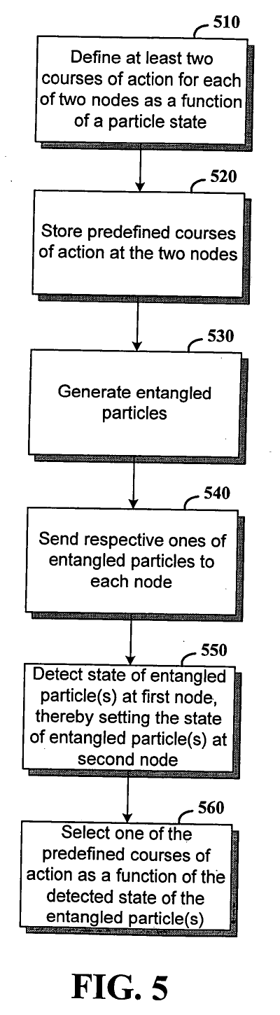

FIG. 5 is a flow diagram showing an approach for selecting an action from a set of predefined actions as a function of the state of quantum-entangled particles, according to another example embodiment of the present invention. The approach shown in FIG. 5 may be implemented, for example, in connection with the system shown in FIG. 4. At block 510, at least two courses of action are defined for each of two nodes as a function of an entangled particle's state. The courses of action are stored at two nodes as shown in block 520 and may, for example, be identical for each node or involve different courses of action that are specifically tailored to each node. Entangled particles are generated at block 530, with respective ones thereof being sent to each node at block 540.

In relatively simple applications, a single set of particles is entangled such that each particle exhibits the same state; in relatively complex applications, two or more sets of entangled particles are generated, each set having its own state that is generally independent from the state of the other set(s). At block 550, the state of one or more entangled particles (depending upon the number of sets of particles generated and needed for the particular implementation) is detected. This detection of the state of one or more entangled particles then fixes the state of other particles entangled therewith, as discussed above. At block 560, one of the predefined courses of action is selected as a function of the detected state of each entangled particle.

The courses of action defined at block 510 vary from very simple to complex, depending upon the implementation. For example, a simple two-option (e.g., yes/no) type agreement can be established at block 510, where first and second states detected at block 550 are used to respectively select a first and second option at block 560. When an entangled particle exhibits a positive or negative characteristic, the positive and negative characteristics can be respectively attributed to “yes” and “no” options. When a positive characteristic is detected, the “yes” option is implemented; accordingly, when a negative characteristic is detected, the “no” option is implemented.

Another two-option type agreement may involve a business alternative, with two (or more) alternatives being defined by the state of entangled particles. A first entity can predefine two courses of action, either by agreeing upon the courses of action with a second entity or independently setting the courses of action. Courses of action may include, for example, a decision related to the timing of an entry into a particular market, the positioning of offerings and the establishment of one or more transaction parameters. These predefined alternatives are shared with the second entity, with both entities receiving the quantum-entangled particles (prior to the detection of the state thereof). When the state of the quantum-entangled particles is detected by one of the entities, the state of the other quantum-entangled particles is set. With this approach, both business entities know which business alternative will be selected and performed, allowing the second entity to audit the action of the first entity.

Complex courses of action can also be established at block 510, such as those depending upon combined states of more than one entangled particle or upon a processed output generated as a function of the state of one or more entangled particles. For instance, when a predefined course of action relies upon characteristics other than the state of the entangled particle(s), the detected state at block 550 is input to a function involving the other characteristics as well as the state of the entangle particle(s). The function then produces an output that is used to select one of the predefined courses of action at block 560.

In a more particular example embodiment of the present invention, a complex economic course of action is executed using the approach shown in FIG. 5, with a variety of characteristics being used in connection with a random particle state to select a predefined course of action. For example, where multiple economic equilibria exist for a particular economic system involving two or more entities, decisions relating to a course of action are chosen as a function of predefined options involving the economic equilibria. The use of this random approach involving quantum-entangled particles in connection with predefined actions reduces the possibility of one entity acting unfairly by gaining knowledge about another entity's decision, prior to making its own decision. In addition, this approach eliminates reliance upon a third party for generating a random input, further eliminating the opportunity for unfairness and thereby facilitating confidence in cooperation between two distinct entities (nodes).

In another particular example embodiment, a complex course of action involving different predefined actions at different nodes is carried out to effect coordinated decisions having a random appearance. For example, when two different nodes benefit from coordination involving related subject matter, but to different ends, different courses of action are predefined at each node. These different courses of action may, for example, involve characteristics that are related to actions performed at the other node or to environmental characteristics as well as to the state of an entangled particle or of several particles.

One type of implementation to which the example embodiment discussed in the previous paragraph may be applicable involves the coordination of bidding among different participants in an auction for goods. If a particular group of participants wishes to maximize the group's needs while limiting spending among the different participants, environmental characteristics such as the selling price, relatedness and respective value of the goods are used in the coordination of bidding. Each participant uses these and other characteristics, along with a random input defined by the state of the entangled particle (or states of particles, when more than one particle is used), to define an individual bidding approach. For example, a coordination approach may include the production of a quantum state given by an entangled state. For the case of two particles, such an entangled state could be written as:
|S>=a|AA>+a|BB>+b|AB>+b|BA>.
The constants a and b can be chosen to favor a particular outcome and also subjected to the normalization condition represented by:
2|a|²+2|b²=1,
which allows selection of the constants to balance a cost difference between items desired by the group.

Other aspects and embodiments of the present invention will be apparent to those skilled in the art from consideration of the specification and practice of the invention disclosed herein. For instance, a variety of approaches to the use of quantum entangled particles involving many different types of particles and entanglement, such as entanglement in opposite states, can be implemented with one or more of the example embodiments discussed herein. It is intended that the specification and illustrated embodiments be considered as examples only, with a true scope and spirit of the invention being indicated by the following claims.

1. A method for coordinating predefined actions for at least two nodes, the method comprising:
generating at least two quantum-entangled particles;
defining at least two selectable actions at each of the nodes, a first one of the at least two selectable actions being identified by a first quantum state and a second one of the at least two quantum-entangled particles being identified by a second quantum state that is different than the first quantum state;
sending a respective one of the quantum-entangled particles to each of the at least two nodes;
detecting a state of a first one of the quantum-entangled particles at a first one of the nodes, whereby a state of each other of the quantum-entangled particles is fixed to the detected state of the first one of the quantum-entangled particles;
after detecting the state of the first one of the quantum-entangled particles, detecting the fixed state of a second one of the quantum entangled particles at a second one of the nodes; and
for at least one of the first and second nodes, selecting and performing one of the at least two predefined actions, in part, as a function the detected state of the quantum-entangled particles and the quantum-state identification of the predefined actions.

2. The method of claim 1, wherein selecting and performing one of the at least two predefined actions as a function the detected state of the quantum-entangled particles and the quantum-state identification of the predefined actions includes comparing the detected state to the quantum-state identifications and, in response to finding a matching state, performing the predefined actions identified by the matching state.

3. The method of claim 1, wherein selecting and performing one of the at least two predefined actions as a function the detected state of the quantum-entangled particles and the quantum-state identification of the predefined actions includes:
generating a pseudorandom code as a function of the detected state of the quantum-entangled particles; and
selecting and performing one of the at least two predefined actions as a function of the pseudorandom code.

4. The method of claim 3, wherein generating a pseudorandom code includes generating a substantially similar pseudorandom code at both of the first and second nodes.

5. The method of claim 4, further comprising storing characteristics of the pseudorandom code at the first and second nodes, wherein generating a pseudorandom code at both of the first and second nodes includes generating a pseudorandom code as a function of the stored characteristics and the detected state of quantum-entangled particles.

6. The method of claim 1, wherein generating at least two quantum-entangled particles includes generating quantum-entangled pairs of photons and wherein sending a respective one of the quantum-entangled particles to each of the at least two nodes includes sending a respective one of the photon pairs to each of the at least two nodes.

7. The method of claim 6, wherein generating quantum-entangled pairs of photons includes generating pairs of photons having consistent polarization and wherein selecting and performing one of the at least two predefined actions includes generating a result that is consistent for each node as a function of the polarization.

8. The method of claim 1, further comprising:
identifying an expected lifetime of the entangled state of the quantum-entangled particles; and
wherein detecting a state of a first one of the quantum-entangled particles and detecting the fixed state of a second one of the quantum-entangled particles includes detecting the states prior to the expected lifetime expiring.

9. The method of claim 1, further comprising:
regenerating the at least two quantum-entangled particles as a function of a predefined interval;
sending a respective one of the regenerated quantum-entangled particles to each of the at least two nodes; and
wherein detecting a state of a first one of the quantum-entangled particles and detecting the fixed state of a second one of the quantum-entangled particles include detecting the states of the regenerated quantum-entangled particles.

10. The method of claim 9, wherein regenerating the at least two quantum-entangled particles as a function of a predefined interval includes regenerating the at least two quantum-entangled particles when an expected lifetime of the entanglement of the quantum-entangled particles expires before the state of the first and second quantum-entangled particles is detected.

11. The method of claim 1, wherein defining at least two selectable actions includes defining two selectable actions at a first node, further comprising sending the two selectable actions to a second node and using the detected state of the quantum-entangled particles and the two selectable actions at the second node to audit the selection and performance of one of the two selectable actions at the first node.

12. The method of claim 1, wherein selecting and performing one of the at least two predefined actions includes independently selecting and performing one of the at least two predefined actions.

13. The method of claim 12, wherein independently selecting and performing one of the at least two predefined actions includes selecting and performing one of the at least two predefined actions at a first one of the nodes without communicating with other ones of the nodes after sending the respective one of the quantum-entangled particles to each of the at least two nodes.

14. The method of claim 1, wherein defining at least two selectable actions at each of the nodes includes defining at least two encryption functions at each of the nodes and wherein selecting and performing one of the at least two predefined actions includes selecting and performing one of the at least two encryption functions.

15. A method for generating an output for at least two nodes, the method comprising:
generating at least two sets of quantum-entangled particles, each set including at least two quantum-entangled particles;
sending a respective one of each set of quantum-entangled particles to each of the at least two nodes;
for each set of quantum-entangled particles, detecting a state of a first one of the quantum-entangled particles at a first one of the nodes, whereby a state of each other of the quantum-entangled particles is fixed to the detected state of the first one of the quantum-entangled particles;
for each set of quantum-entangled particles, after detecting the state of the first one of the quantum-entangled particles, detecting the fixed state of a second one of the quantum entangled particles at a second one of the nodes; and
at each of the first and second nodes, generating an output as a function the detected states of the quantum-entangled particles from each set of quantum-entangled particles.

16. The method of claim 15, wherein generating an output as a function the detected states of the quantum-entangled particles from each set of quantum-entangled particles includes comparing the detected states of at least two quantum-entangled particles at each node and performing a first function in response to the detected states that match and performing a second function in response to the detected states that do not match.

17. The method of claim 15, wherein generating an output as a function the detected states of the quantum-entangled particles from each set of quantum-entangled particles includes generating at least two inputs as a function of the detected states and processing the inputs to generate the output.

18. The method of claim 17, further comprising defining an encoding function, wherein generating at least two inputs includes generating at least two bits for the encoding function and wherein processing the inputs to generate the output includes processing the inputs with the encoding function to generate a coding output.

19. A method for coordinating timing of actions at first and second nodes, the method comprising:
generating at least two quantum-entangled particles;
sending a respective one of the quantum-entangled particles to each of the first and second nodes;
detecting a state of a first one of the quantum-entangled particles at the first node, whereby a state of each other of the quantum-entangled particles is fixed to the detected state of the first one of the quantum-entangled particles;
detecting a state of a second one of the quantum entangled particles at the second node after detecting the state of the first one of the quantum-entangled particles; and
at the first and second nodes, executing a response at a coordinated time selected as a function of the detected states of the quantum-entangled particles.

20. The method of claim 19, wherein executing a response at a coordinated time selected as a function of the detected states of the quantum-entangled particles includes, at each of the first and second nodes, processing the detected state to generate an output indicative of the coordinated time and viewable by a user.

21. A system for coordinating predefined actions for at least two nodes, the system comprising:
means for generating at least two quantum-entangled particles;
means for defining at least two selectable actions at each of the nodes, a first one of the at least two selectable actions being identified by a first quantum state and a second one of the at least two quantum-entangled particles being identified by a second quantum state that is different than the first quantum state;
means for sending a respective one of the quantum-entangled particles to each of the at least two nodes;
means for detecting a state of a first one of the quantum-entangled particles at a first one of the nodes, whereby a state of each other of the quantum-entangled particles is fixed to the detected state of the first one of the quantum-entangled particles;
after detecting the state of the first one of the quantum-entangled particles, means for detecting the fixed state of a second one of the quantum entangled particles at a second one of the nodes; and
for at least one of the first and second nodes, means for selecting and performing one of the at least two predefined actions as a function the detected state of the quantum-entangled particles and the quantum-state identification of the predefined actions.

22. A system for coordinating predefined actions for at least two nodes using at least two selectable actions, a first one of the at least two selectable actions being identified by a first quantum state and a second one of the at least two quantum-entangled particles being identified by a second quantum state that is different than the first quantum state, the system comprising:
an entangled particle generator adapted to generate at least two quantum-entangled particles;
a communications link adapted for sending a respective one of the quantum-entangled particles to each of the at least two nodes;
a particle detector adapted to detect a state of a first one of the quantum-entangled particles at a first one of the nodes, whereby a state of each other of the quantum-entangled particles is fixed to the detected state of the first one of the quantum-entangled particles;
another particle detector adapted to detect the fixed state of a second one of the quantum entangled particles at a second one of the nodes, after the state of the first one of the quantum-entangled particles is detected; and
for at least one of the first and second nodes, a selection arrangement adapted to select and facilitate the performance of one of the at least two predefined actions as a function the detected state of the quantum-entangled particles and the quantum-state identification of the predefined actions.
